(19) United States
(12) Patent Application Publication
(10) Pub. No.: US 2016/0286733 A1
(43) Pub. Date: Oct. 6, 2016

(54) AGRICULTURAL SYSTEM AND METHOD

(71) Applicant: Robert Fair, Rolling Hills Estates, CA (US)

(72) Inventor: Robert Fair, Rolling Hills Estates, CA (US)

(21) Appl. No.: 15/090,944

(22) Filed: Apr. 5, 2016

Related U.S. Application Data
(60) Provisional application No. 62/143,168, filed on Apr. 5, 2015.

(51) Int. Cl. A01G 9/12; A01G 27/00; A01G 1/00; A01G 7/04

(52) U.S. Cl. CPC A01G 9/12; A01G 7/045; A01G 27/005; A01G 1/001

(57) ABSTRACT

Disclosed herein are devices, systems and methods incorporating mobile agricultural devices. These devices can incorporate various features including growth lattices and internal drainage features and are mobile allowing for agricultural systems with continuous plant production. A user can easily remove and replace plants, for example, vining plants, within a particular growing space based upon their progression within their growth cycle. In some embodiments, the agricultural devices can be incorporated into agricultural systems which can comprise various lighting, drainage and nutrient distribution features.

### CROSS-REFERENCE TO RELATED APPLICATIONS

This application claims the benefit of U.S. Provisional Application Ser. No. 62/143,168 to Robert Fair, filed on 5 Apr. 2015 and entitled THE GROW CART, which is hereby incorporated herein in its entirety by reference.

### BACKGROUND

1. Field of the Invention

Described herein are devices, systems and methods for use in agricultural fields, for example, for the production and growth of plants, for example, vining and branching plants and plants capable of generating a crop production for harvest.

2. Description of the Related Art

Various agricultural systems utilizing different devices and methods have been utilized since the beginning of human civilization to grow a variety of plants, including ornamental plants and fruit/vegetable-producing plants. These various agricultural systems have included both outdoor and indoor systems. Some outdoor systems include carefully cultivated farmland crop rotation systems or even the basic home outdoor garden. Some indoor systems include greenhouses which typically comprise a structure with a plastic or glass roof and frequently glass or plastic walls. The interior of the greenhouse can be heated by incoming solar radiation that warms the plants and soil therein.

Each of these outdoor and indoor agricultural systems have their own advantages and disadvantages. For example, outdoor farmland systems can be utilized to produce large yields of a certain crop, however, unlike in a greenhouse, pests and diseases need to be more tightly controlled and more complex irrigation is necessary to provide water. However, the closed environment of a greenhouse has its own unique requirements, and can be configured to compensate for extreme highs and lows of heat and humidity, and to generally control the environmental conditions such as the level of carbon dioxide (CO2).

Despite the differences in conventional outdoor and indoor agricultural systems, the reoccurring feature that these systems attempt to produce is uniformity over a wide area. For example, large plots of farmland will be designated for a specific strain of crop. Likewise, greenhouses have been developed to equalize temperature and carbon dioxide distribution across an entire growing area so that one portion of the greenhouse crop does not receive a different exposure than another portion.

While the above-described uniformity can be desirable if all the plants are the same strain and around the same period of their growth cycle, if any of the plants differ in strain or where they are with respect to their growth cycle (e.g. how many weeks along they are), they can have different growing tolerances, for example, growing best with different nutrients, light intensity, and water exposure. Taking the example of a vining plant, such as a grape plant, utilizing conventional agricultural systems, a group of grape plants would need to produce the same strain of grape and be along the same progression of their growth cycle to fully benefit from the uniform nature of conventional agricultural systems. Therefore, a user growing the crop of grapes would need to plant several instances of the same stain of grape in a given space at the same time in order to synchronize both the stain of grape and the growth cycle of the plants.

Another disadvantage of conventional agricultural systems is that the crops are fixed in a stationary location from planting until harvest. Accordingly, in order to adjust the levels of various nutrients, water and gas the plants are exposed to, large dispensing machinery would have to be moved and relocated. Furthermore, if the uniformity of the above-mentioned conventional systems failed and one section of the crop grew at a faster rate and needed to be harvested earlier than the other portions of the crop, the newly-harvested portion of the crop would be wasting prime growing space within the growing area, as a user would not want to plant a new crop in that section for fear of further placing the crop as a whole out of synch.

Therefore, what is needed is an efficient and cost effective agricultural system and method for growing a group of plants in a defined space such that plants with varying requirements can be optimally grown together in a common area and that a plant that is ready to be harvested or placed into different conditions can be easily removed from the area and replaced with another plant to continue production.

### SUMMARY

Disclosed herein are devices, systems and methods for providing efficient moveable agricultural devices configured to support and transport a growing plant. This allows a user to easily transport a plant to another area wherein growing conditions are more favorable. These agricultural devices can further incorporate various features to promote the efficient growth of a plant, for example, a vining or branching plant. These agricultural devices can be configured to interact with various lighting system components, drainage system components, and/or nutrient distribution system components to provide advantageous agricultural systems. The system components can be configured such that they can be adjacent to the agricultural devices when in use and can be moved to a location to allow unhindered transportability of the agricultural devices when needed.

In one embodiment incorporating features of the present invention, an agricultural device comprises a body comprising at least one base portion, a growth lattice on the body and positioned a distance away from the base portion, and at least one mobility structure configured to allow the agricultural device to move in relation to the at least one mobility structure.

In another embodiment incorporating features of the present invention an agricultural system comprises at least one agricultural device comprising a body that comprises at least one base portion and at least one mobility structure configured to allow the agricultural device to move in relation to the mobility structure, and a drainage manifold connected to the at least one agricultural device.

In yet another embodiment, an agricultural method comprises providing at least two areas, comprising a first area comprising growing conditions conducive to desirable growth of a specific type of plant within a first stage of its growth cycle and a second area comprising growing conditions conducive to desirable growth of the specific type of plant within a second stage of its growing cycle. The method further comprises providing a first plurality of plants of the specific type of plant within the first stage of its growing cycle on mobile agricultural devices in the first area and providing a second plurality of plants of the specific type of plant within the second stage of their growing cycle on mobile agricultural devices in the second area. The method then further comprises removing at least one plant on a mobile agricultural device within the second plurality of plants from the second area when the plant advances past said second stage of its growth cycle and replacing it with another plant from the first plurality of plants.

These and other further features and advantages of the invention would be apparent to those skilled in the art from the following detailed description, taken together with the accompanying drawings, wherein like numerals designate corresponding parts in the figures, in which:

### BRIEF DESCRIPTION OF THE DRAWINGS

FIG. 1 is a front perspective view of an agricultural device incorporating features of the present invention;

FIG. 2 is a front perspective view of an agricultural system incorporating features of the present invention;

FIG. 3 is a front perspective view of an agricultural system incorporating features of the present invention;

FIG. 4 is a front perspective view of the agricultural system of FIG. 3, shown in a different orientation;

FIG. 5 is a front perspective view of an agricultural system incorporating features of the present invention;

FIG. 6 is a front perspective view of an agricultural system incorporating features of the present invention; and

FIG. 7 is a front perspective view of an overview of an agricultural system incorporating features of the present invention.

### DETAILED DESCRIPTION

The present disclosure will now set forth detailed descriptions of various embodiments. Devices, systems and methods incorporating features of the present invention can include easily and efficiently moveable agricultural devices configured to house and/or support a growing plant. These agricultural devices can be configured to interact with various agricultural system components, for example, lighting system components, drainage system components, and/or nutrient distribution system components. The system components can be configured such that they can be adjacent to the agricultural devices when in use and can be moved to a location to allow unhindered transportability of the agricultural devices when needed.

Utilizing agricultural devices and systems incorporating features of the present invention, a user can easily remove a plant from one environment without harvesting it and place it into another environment that better corresponds to its optimal growth requirements based upon the plant's genetics and where the plant is within its growth cycle. For example, utilizing conventional methods, a greenhouse with a plurality of plants may have some plants within that plurality growing at a faster rate. This can be due to the plants being a different stain, through uneven distribution of nutrients, or through nuances of individual plant genetics. If, for example, the plant were to grow to the point where it was not yet ready for harvest, but is in a point of its growth cycle wherein it has different light and nutrient requirements from other plants in the same area, the plant would simply have to experience sub-optimal conditions. Utilizing devices, systems and methods incorporating features of the present invention, a user would be able to remove this plant from its environment and place the plant into an environment more conducive to its optimal individual growing conditions.

Utilizing devices, systems and methods incorporating features of the present invention, a user could set up a plurality of areas, for example individual rooms or structures (or simply spaces if growing outside) which are subject to one or more conditions. For example, one might set up three rooms, with varying light or nutrient features corresponding to various stages in the growth cycle of a plant, for example, a grape plant. Different strains of grapes that mature at different rates can be grown together. If one plant from the first room reaches the point of its growth cycle earlier than the other plants (where it should be moved into the second room under different conditions), that plant can be moved to the second room and immediately replaced with another plant that is better suited for growing under the conditions of the first room.

The continuous “revolving” nature of this method incorporating features of the present invention allows for continuous optimal growth of every plant throughout its growth cycle. If for example, the third room in the example above corresponds to plants in the portion of their growth cycle that are near ready to harvest, a plant can be harvested when ready and then immediately replaced with a plant from the second room that is near ready to grow under the conditions of the third room. Therefore, plants can be continuously cycled through conditions without empty space being used up.

Without the transportable agricultural devices incorporating features of the present invention, a space previously occupied by a harvested plant in a room with growing conditions (e.g. gas level, nutrient concentration and light) corresponding to late growth cycle optimal conditions would have to remain empty, as newly planted plants early within their growth cycle would not grow optimally under late growth cycle conditions.

The individual components of the various devices and systems can further customize growing environments allowing for plants with different optimal growing conditions to be optimally grown in the same or similar environment. These individual components are described in more detail further below.

Throughout this description, the preferred embodiment and examples illustrated should be considered as exemplars, rather than as limitations on the present invention. As used herein, the term “invention,” “device,” “system,” “method,” “present invention,” “present device,” “present system” or “present method” refers to any one of the embodiments of the invention described herein, and any equivalents. Furthermore, reference to various feature(s) of the “invention,” “device,” “system,” “method,” “present invention,” “present device,” “present system” or “present method” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms, such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein, but are to include deviations in shapes that result, for example, from manufacturing.

It is understood that when a first element is referred to as being “between,” “sandwiched,” or “sandwiched between,” two or more other elements, the first element can be directly between the two or more other elements or intervening elements may also be present between the two or more other elements. For example, if a first element is “between” or “sandwiched between” a second and third element, the first element can be directly between the second and third elements with no intervening elements or the first element can be adjacent to one or more additional elements with the first element and these additional elements all between the second and third elements.

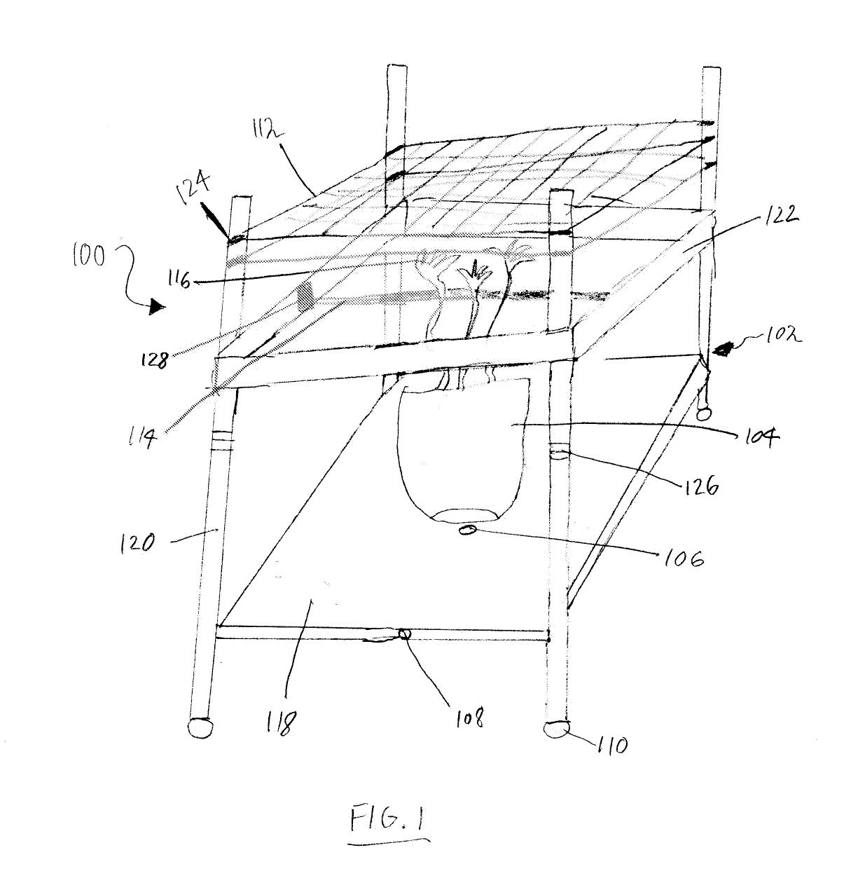

An example embodiment of an agricultural device 100 incorporating features of the present invention is shown in FIG. 1. The agricultural device 100 can comprise a body 102 configured to receive and/or support at least one plant-retaining structure 104, an internal drainage system, for example, comprising an input drainage structure 106 and an output drainage structure 108, and one or more mobility structures 110 (four shown). In some embodiments, the agricultural device 100 can further comprise a growth lattice 112 and/or an internal lighting element 114. The agricultural device 100 can be utilized with a variety of different system components to provide different agricultural system embodiments as is described in more detail further herein.

The body 102 can comprise any material that is structurally sound and suitable for supporting a growing plant, such as the example growing plant 116 shown. The body 102 can comprise any suitable shape, for example, any regular or irregular polygon, with the preferred shape being a shape that can facilitate or encourage the growth of one or more plants, for example, by accommodating connection of a growth lattice 112. In the embodiment shown in FIG. 1, the body comprises three major portions, a base portion 118, one or more post portions 120 (four shown), and an architectural support portion 122.

In the embodiment shown in FIG. 1, the base portion 118 of the body 102 serves as a base for supporting a plant, for example being a base for plant-retaining structure 104 to rest upon. The body 102 can also be configured to integrate additional features, for example, various drainage features 106, 108, as will be discussed in more detail further below. In the embodiment shown, the base portion 118 is shown to be roughly square in shape, although it is understood that other shapes and orientations are possible as discussed above. The post portions 120 are shown positioned substantially perpendicular to the base portion 118 and extending in a vertical direction, although different orientations are possible. The post portions 120 can extend a distance away the base portion 118 in one or more directions, for example, in an upward direction, such that a connected feature such as the growth lattice 122 can be connected to the post portions 120, being a distance away from and interacting with a growing plant on the base portion 118 as is described in more detail further below. Likewise, the post portions 120 can extend in a downward direction and connect to one or more mobility structures 110.

The architectural support portion 122 is configured to provide additional mechanical support to the post portions 120. Advantages of the body 102 configuration shown in FIG. 1 include that the body is structural sound, allowing for stable mobility of the agricultural device 100 and that additional features, such as the growth-lattice 112 can be integrated into the agricultural device 100.

The body 102 can comprise a wide variety of materials, with the preferred material being a material that is mechanically sturdy and can substantially maintain a desired shape. Some examples of suitable material that can support the structure and function of the agricultural device 100 as set forth in the present disclosure include are, but not limited to resin, rubber, vinyl, polyurethane, poly vinyl chloride (PVC), Poly(methyl methacrylate) (PMMA), polystyrene foam, various polymers/copolymer substances, acrylic substances, plastic, leather, metal, glass, fiberglass, wood or a combination thereof.

The plant-retaining structure 104 can be any structure suitable to house a plant, for example, a plant planted in soil or suspended in a growth medium, for example, a liquid growth medium. A preferred configuration of a plant-retaining structure 104 is any configuration capable of supporting plant growth with a single root system. In some embodiments, the plant-retaining structure 104 is an integrated part of the agricultural device 100, such that it is part of the body 102 or physically connected to the body 102. In some embodiments, the plant retaining structure is separate from the body 102 and is simply configured with the body 102, for example, being placed on a base portion 118 of the body 102 as shown in FIG. 1. In some embodiments, plant-retaining structure 104 can be a conventional plant container.

The agricultural device 100 can further comprise drainage components 106, 108, for example, an input drainage structure 106 and an output drainage structure 108. These structures can be internal and/or integrated with a portion of the body 102, for example the base portion 118 (as shown), or can be separate from the body 102. The input drainage structure 106 is configured and connected with the output drainage structure 108 such that excess liquid from the plant 116, for example, excess water or liquid nutrients provided to the plant, can enter the input drainage structure 106 and exit the output drainage structure 108. The drainage structures can be connected via piping, for example, PVC piping internal to the body 102 of the agricultural device 100 or via any known conventional plumbing systems and methods.

In typical configuration, the plant 116 and/or the plant-retaining structure 104 is configured such that it is on, over, or adjacent to the input drainage structure 106. This allows leakage of excess liquid from the plant to flow into the input drainage structure 106 and subsequently out of output drainage structure 108. The drainage structures 106, 108 can be further configured with additional plumbing structures in a larger agricultural system as is described in more detail below.

In some embodiments, the drainage structures 106, 108 are configured such that gravity facilitates the flow of excess liquid from the input drainage structure 106 to the output drainage structure 108. This can be accomplished in several ways, for example, by configuring internal piping connecting the input drainage structure 106 to the output drainage structure 108 such that the piping is tilted in a manner that facilitates the flow of liquid between the two drainage structures 106, 108 via gravity. In other embodiments, one or more portions of the body 102, for example, the base portion 118 are tilted to achieve a similar effect. It is important to recognize that if the base portion 118 is configured to be tilted, it should preferably be stable enough to support the plant-retaining structure 104, without the plant 116 sliding off the device during device transport.

The agricultural device 100 can further comprise one or more mobility structures 110. These mobility structures 110 are configured to allow easy mobility of the agricultural device 100, for example, facilitating the movement of the agricultural device 100 from various rooms within an interior growing facility to expose a plant 116 to various growth conditions. In the embodiment shown in FIG. 1, the mobility structures comprise wheels connected to the bottom portions of the post portions 120 of the body 102. This allows a user to wheel the agricultural device 100 across a floor for easy transport. Although, the mobility structures 110 are shown connected to the post portions 120 of the body 102, the mobility structures 110 can be connected to or configured with other portions of the agricultural device 100. For example, in some embodiments not comprising post portions 120 or comprising post portions 120 that do not extend past the bottom of the base portion 118, the mobility structures can instead be connected to the base portion 118 to allow for efficient movement of the agricultural device.

In embodiments utilizing post portions 120, a user can easily grip one or more post portions and push and/or pull the agricultural device 100 in a desired direction such that it moves with respect to the mobility portions 110. While the embodiment depicted in FIG. 1 shows the mobility portions 110 comprising wheels or wheel-like structures, other mobility structures can be utilized, including any structure that can decrease and/or mitigate friction with a floor to improve mobility of the agricultural device 100. In some embodiments, the mobility portions 110 comprise sleds, caterpillar tracks, spheres (such as ball-bearing or “hamster-wheel-like” structures), various walking machines (including robotic-based machines), hovercraft-like devices and pedrail wheels. As technology improves, it is contemplated that various “hover” technologies, including superconductor-based technologies can be utilized as mobility portions 110 in agricultural devices incorporating features of the present invention.

The agricultural device 100 can further comprise one or more growth lattices 112. The growth lattice 112 is on and configured with a portion of the body 102, for example, a post portion 120 of the agricultural device 100 a distance away from the plant 116, such that the plant 116, for example, a vining plant can grow into the space occupied by the growth lattice 112 and entangle and/or rest upon and/or within the growth lattice 112. The growth lattice 112 causes the plant to detect that its branches are stronger and more sturdy than they are in reality as the parts of the plant interacting with the growth lattice 112 are being mechanically supported by the growth lattice 112. This causes the plant to grow larger and at a greater rate. The growth lattice 112 can comprise any suitable material for proving mechanical support to portions of a growing plant 116. In some embodiments, the growth lattice 112 comprises a string, mesh or twine-like structure. The growth lattice can comprise any suitable shape to facilitate growth of the plant 116 and typically comprises a weave-like shape with linear support portions and spaces therebetween.

One or more portions of the body 102 can comprise one or more hash marks 124. These hash marks 124 indicate desired placement positions for the growth lattice 112. The preferred configuration of a growth lattice 112 will depend on the type of plant being grown. For example, a different growth lattice shape, as well as a different position in relation to the body 102 of the agricultural device 100, will be ideal if a plant has a horizontal growth pattern versus a vertical growth pattern. The hash marks 124 allow the agricultural devices to be manufactured with specific indicators to a user as to where the best location to install a growth lattice 112 is. For example, a certain variety of grape may respond well to a growth lattice 112 that comprises a certain shape, weave pattern and position in relation to the body 102 of the agricultural device 100. The hash marks 124 can be etched, carved or marked on a portion of the body 102 of the device 100 to indicate this desired position and a version of the agricultural device 100 can be marketed to users as being specifically adapted for the growth of that particular strain of grape.

Embodiments of the agricultural device 100 that comprise the post portions 120 are particularly suited for integration of a growth lattice 112. The growth lattice 112 can be configured such that it is connected to raised portions of one or more post portions 120, allowing a plant to grow upward into the growth lattice 112. In some embodiments, the post portions 120 can comprise one or more adjustment features 126 that can lengthen or shorten the effective length of the post portions 120. The adjustment features 126 can comprise any configuration capable of changing the effective length of the post portions 120. In the embodiment shown, the adjustment features 126 comprise a “telescopic” configuration, wherein an inner segment of a post portion 120 can sink into an outer segment of the post portion 120, effectively altering the length of the post portion 120. This allows the distance from the growing plant 116 to the growth lattice 112 to be adjusted.

In some embodiments, the agricultural device 100 can comprise one or more internal lighting elements 114. The internal lighting elements 114 can include incandescent lighting elements, light emitting diodes (LEDs), or LED-based lighting elements such as LED lighting tubes and/or any conventionally known lighting elements. These internal lighting elements 114 can be positioned and configured such that they are intermingled with the growing plant 116 and can therefore provide light to more areas of the growing plant than a light simply positioned above the plant. The internal lighting elements 114 can be selected to provide a preferred light output to a particular stain of plant. For example, a particular strain of grape might respond best to red-spectrum light. In this case, a red-spectrum LED lighting tube can be utilized as the internal lighting element 114 to provide the desired light.

In some embodiments, the internal lighting elements 114 can be connected to the body 102 by one or more moveable connection elements 128, that allow the internal lighting elements 114 to move with respect to the body. Examples of suitable moveable connection elements 128 include hinges, living hinges, ball-and-socket connections, and/or any known conventional moveable connection structures.

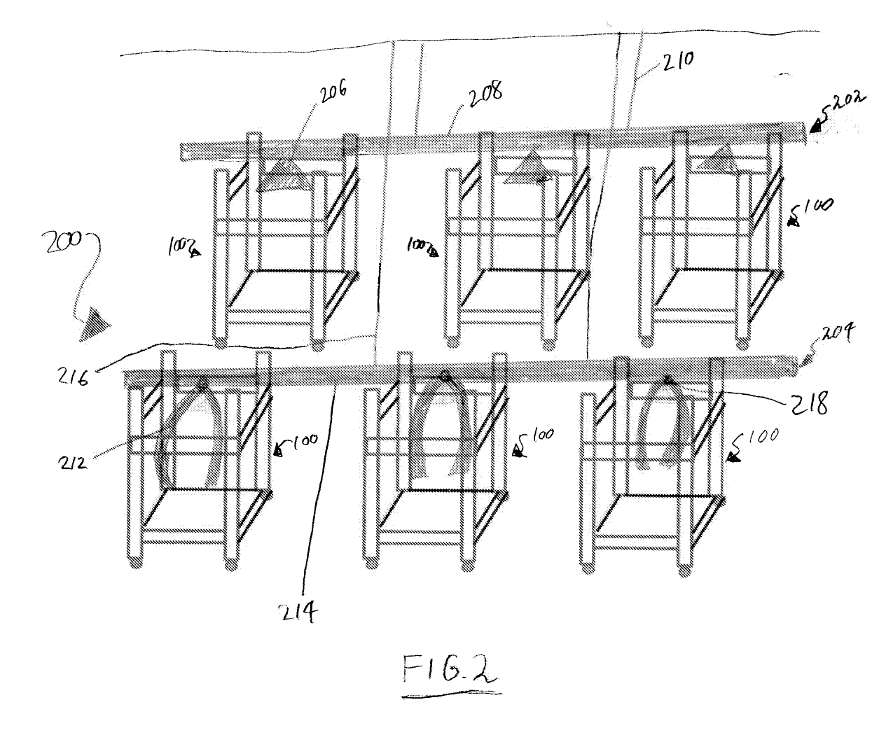

While internal lighting elements 114 integrated into the body 102 of the agricultural device 100 are discussed above, external lighting elements can also be utilized. Furthermore, the individual agricultural device 100 can be incorporated with additional features to result in an agricultural system. An example of one such agricultural system 200 is shown in FIG. 2, which shows six agricultural devices 100, positioned in a growing room with two forms of external light structures: an overhead external light structure 202 and an integrating external light structure 204. The overhead external light structure 202 comprises one or more overhead lighting elements 206, a first base member 208 and a first lighting suspension mechanism 210. The integrating external light structure 204 comprises one or more integrating lighting elements 212, a second base member 214 and a second lighting suspension mechanism 216. While the embodiment shown in FIG. 2 shows two different types of light structures 208, 214 it is understood that a system can utilize the same light structure for a given space or more than two different types of light structures for a given space.

The overhead external light structure 202 comprises overhead lighting elements 206 that are configured to provide light to plants growing in the agricultural devices 100. The overhead lighting elements 206 are connected to the first base member 208 and can be configured such that they can move with respect to the first base member 208, for example, such that they can slide laterally with respect to the first base member 208. This allows the overhead lighting elements 206 to be adjustable such that they can be configured to provide direct or indirect light to a plant in a given agricultural device or to adjust the amount of light provided to a given agricultural device 100. The first base member 208 can comprise a variety of suitable shapes, sizes and materials, for example, comprising materials similar to the body of the agricultural device 100, with the preferred configuration being a shape or material that suitably supports the weight and structure of the overhead lighting elements 206. In some embodiments, the first base member 208 comprises a metal rail-like structure.

The first base member 208 can be adjusted and/or moved, for example, by raising or lowering the first lighting suspension mechanism 210. This will in turn move the overhead lighting elements 206 that are connected to the first base member 208. The first lighting suspension mechanism 210 can comprise a variety of shapes, materials and configurations, for example, comprising materials similar to the body of the agricultural device 100, with the preferred configuration being a shape or material that suitably supports the weight and structure of the first base member 208 and the connected overhead lighting elements 206.

In some embodiments, the first lighting suspension mechanism 210 can comprise a cable or wire-like structure. In some embodiments, the first lighting suspension mechanism 210 can comprise a bar or pole-like structure. It is also understood that in some embodiments, the first suspension mechanism 210 can be connected directly or indirectly to one or more overhead lighting elements 206 without the need of the first base member 208. One advantage of utilizing the first base member 208 is that an entire plurality of agricultural devices 100 can be easily provided with uniform or near uniform light conditions.

As mentioned above, the first lighting suspension mechanism 208 can be moveable and/or adjustable such that the first base member 208 and any connected overhead lighting elements 206 can be moved. This allows a user of the system 200 to move the lighting elements 206 to close proximity to the agricultural devices 100 or further away from the agricultural devices 100. In this way, the amount of light provided to the agricultural devices 100 can be adjusted.

Furthermore, by moving the first base member 208 and any connected overhead lighting elements 206 to a location further from the agricultural devices 100, for example, raising the first base member 208 and connected overhead lighting elements 206 upward toward the ceiling, agricultural devices 100 can be easily transported into and out of the agricultural system 200 without difficulty, for example, without bumping and damaging an overhead lighting element 206. This is important should one plant in one particular agricultural device 100 be a different strain or in a different part of its growth cycle than other plants being exposed to a uniform lighting arrangement, it can be removed and placed into a different system that is more conducive to its growth. Likewise, another plant in another agricultural device 100 can be substituted into the agricultural system 200 to replace the removed plant. This allows for continual growing without wasting space.

The first lighting suspension mechanism 208 can be configured to be adjustable utilizing any suitable structure capable of raising or lowering the first base member 208 and any connected overhead lighting elements 206. In some embodiments, the first lighting suspension mechanism 210 comprises a pulley structure, for example, a wheel on an axle or shaft that is designed to support movement and change of direction of a cable or belt along its circumference. In some embodiments, the first lighting suspension mechanism 210 may comprise a groove between two flanges around its circumference with a drive element of a rope, cable, belt, or chain that runs over inside the groove.

In some embodiments, the first lighting suspension mechanism 210 can comprise a pole-like structure moveably connected to a wall or the ceiling allowing a user to move the first base member 208 and any connected overhead lighting elements 206 to and away from the agricultural devices 100, for example, hinges, living hinges, ball-and-socket connections, and/or any known conventional moveable connection structures. In some embodiments, the first lighting suspension mechanism 210 can comprise telescopic features allowing the length of the first lighting suspension mechanism 210 to be adjusted. In some embodiments, the first base member 208 and any connected overhead lighting elements 206 can be configured to fold into a compartment in the ceiling or a nearby wall when not in use.

Discussing now the integrating external light structure 204, the second base member 214 and a second lighting suspension mechanism 216 is similar to the first base member 208 and the first lighting suspension mechanism 210 above and the description of those elements in incorporated herein into this embodiment as well. One of the ways that the integrating external light structure 204 differs from the overhead external light structure 202 is that instead of utilizing overhead lighting elements 206, which provide light downward from a position above an agricultural device 100, the integrating external light structure 204 utilizes integrating lighting elements 212, which are similar to the internal lighting element 114 in FIG. 1 above and can comprise similar materials configurations and structures. In some embodiments, the integrating lighting elements 212 comprise LED lighting tubes.

In some embodiments, the integrating lighting elements 212 can be positioned such that they are within the canopy of a growing plant, therefore providing light to areas that typically receive insufficient light from an overhead lighting element 206. In some embodiments, the integrating lighting elements 212 comprise a moveable “rib-cage-like” structure wherein they are connected to the second base member 204 by an integrating moveable connection 218. This allows the integrating lighting elements 212 to move closer to or further apart from one another, providing a further level of customization of light output to a growing plant.

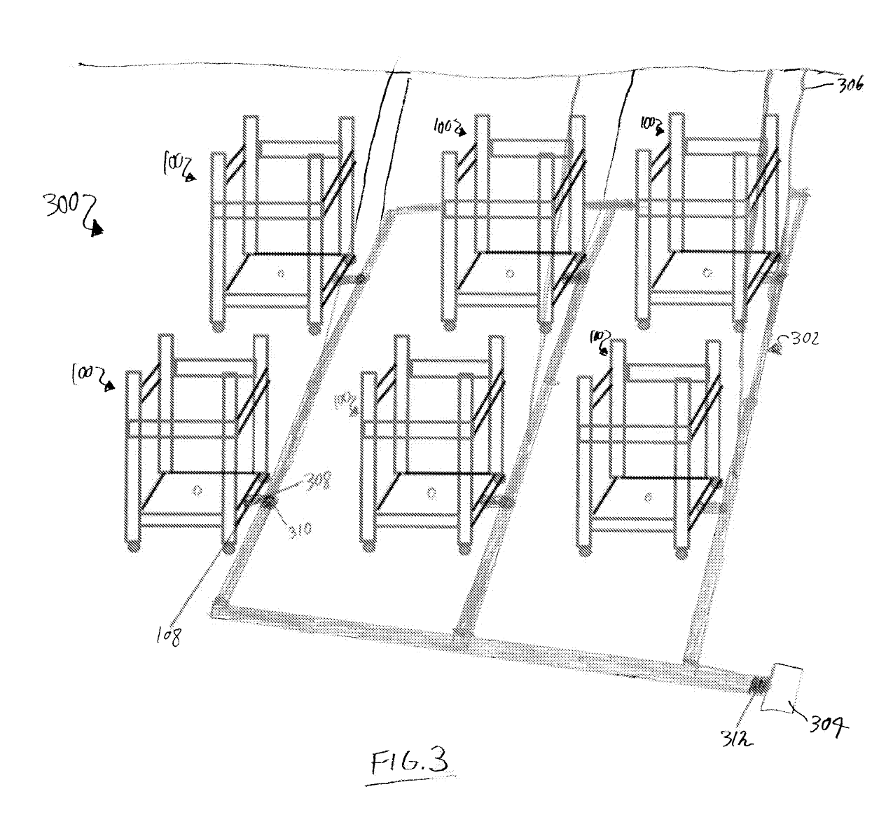

In addition to lighting systems, agricultural devices incorporating features of the present invention can be incorporated into drainage systems. FIG. 3 shows an agricultural system 300 comprising one or more agricultural devices 100 (six shown) and a drainage manifold 302. The system 300 can further comprise a drainage removal portion 304. The drainage manifold 302 can comprise any suitable distribution conduits capable of draining excess liquid from growing plants within the agricultural devices and transporting the excess liquid to the drainage removal portion 304, which can comprise any structure from removing the excess liquid from the system, for example, a tank for storage and later removal of the excess liquid or a pathway to a sewer or city water removal line. In some embodiments, the drainage manifold comprises a metal, plastic or PVC material.

Like with the overhead external light structure 202 and the integrating external light structure 204 in FIG. 2 above, the drainage manifold 302 comprises a suspension mechanism, in this case one or more drainage suspension mechanism 306 (three shown). The drainage suspension mechanism 306 can comprise a similar structure, material and/or configuration to the first and second lighting suspension mechanisms 210, 216 describe in relation to FIG. 2 above and the corresponding disclosure is incorporated into this embodiment. The drainage suspension mechanism allows the drainage manifold 302 to be moved out of the way to facilitate easy of transportation of agricultural devices 100, when the drainage manifold is not in use or when an agricultural device needs to be removed or added to the agricultural system 300.

FIG. 3 shows the drainage manifold 302 in use and connected to each of the agricultural devices 100. The drainage manifold comprises drainage connection portions 308, which are configured to removably connect to the output drainage structures 108 of the agricultural devices 100, such that the drainage manifold 302 can be connected to and disconnected from the agricultural devices based upon the needs of the user. When excess liquid enters the input drainage structures 106 of the agricultural devices and subsequently exits the agricultural devices 100 from the output drainage structures, the excess liquid enters into the drainage manifold 302 through the drainage connection portions and is then transported to the drainage removal portion 304.

The drainage manifold 302 can be configured so that it has specifications consistent with the individual agricultural devices 100, for example, such that it can be raised toward the ceiling when not in use and the agricultural devices can be placed into position such that the lowering of the drainage manifold will result in near-perfect alignment of the drainage connection portions 308 of the drainage manifold 302 with the output drainage structures 108 of the agricultural devices 100. To further ensured ease of alignment, for example, in embodiments, wherein the drainage manifold 302 comprises a rigid piping structure, the drainage connection portions 308 can be connected to the drainage manifold 302 by a moveable drainage connection 310, which can comprise a moveable connection such as those described elsewhere herein, for example, a hinge or ball-and-socket connection. This moveable drainage connection 310 allows for easier connection to the output drainage structures 108 of the agricultural devices 100 and helps to compensate from alignment issues in embodiments wherein the drainage manifold 302 has a limited number of fixed positions, for example, being limited to a limited number of raised and lowered positions.

The drainage manifold 302 can comprise a pump 312 that is configured to facilitate transport of liquid from inside the drainage manifold to the drainage removal portion 304, for example, by creating a negative pressure within the drainage manifold. It is understood that in lieu of or in addition to a pump 312 other known fluid transportation mechanisms can be utilized, for example, fluid transportation mechanisms based upon capillary action.

It is also understood that a pump 312 is not strictly needed. The drainage manifold 302 can be configured such that liquid within is transported to the drainage removal portion primarily or at least partially by gravity both in embodiments with and without a pump 312. This can be achieved, for example, by designing the drainage manifold 302 to have a slanted or sloped configuration in one or more portions that allows liquid within to naturally flow toward the drainage removal portion 304 in a direction consistent with gravity. As the acceleration of gravity on Earth is constant, this configuration can provide a uniform drainage flow. Another way to achieve this effect is to have the drainage manifold 302 rest against a sloped floor while connected to the agricultural devices 100 when it is in use.

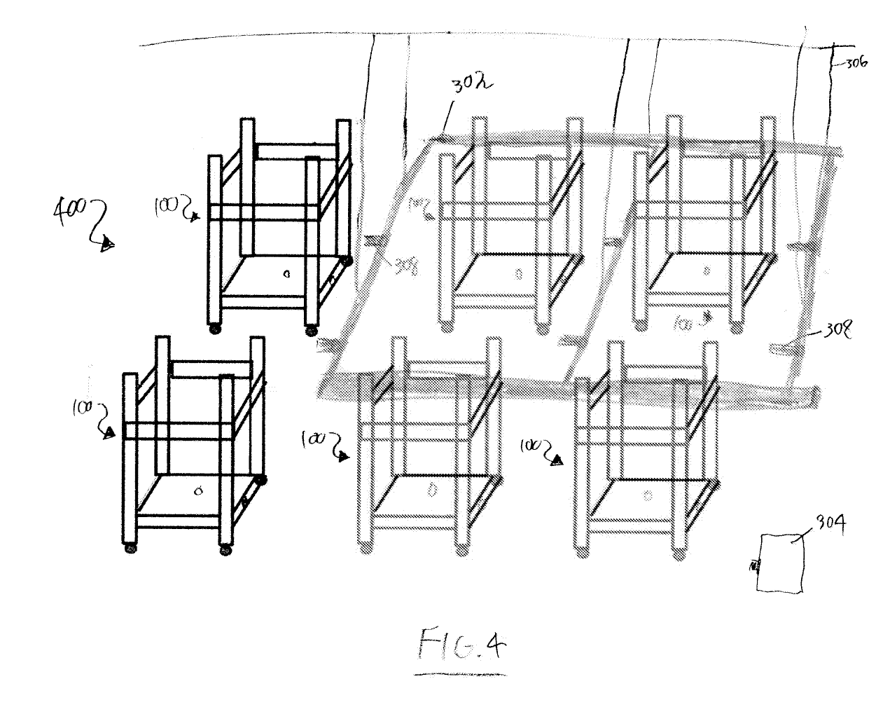

A configuration 400 of the agricultural system of FIG. 3 wherein the drainage manifold 302 is raised to the ceiling and not in use is shown in FIG. 4, which shows the agricultural devices, the drainage manifold 302, the drainage removal portion 304, the drainage suspension mechanisms 306, and the drainage connection portions 308. This configuration 400 shown in FIG. 4 shows that the drainage manifold 302 can be disconnected from the agricultural devices 100 and the drainage removal portion 304 and moved to a different location, for example, near the ceiling of a room, through the drainage suspension mechanisms 306. This allows for the easy movement and substitution of agricultural devices 100 within the system.

While the embodiments shown in FIGS. 3-4 describe a drainage manifold 302 that is common to all connected agricultural devices 100, it is understood that the multiple drainage manifolds could be employed such that a single agricultural device 100 or only a few agricultural devices 100 within a plurality would share a single drainage manifold 302, while others would share a separate drainage manifold 302.

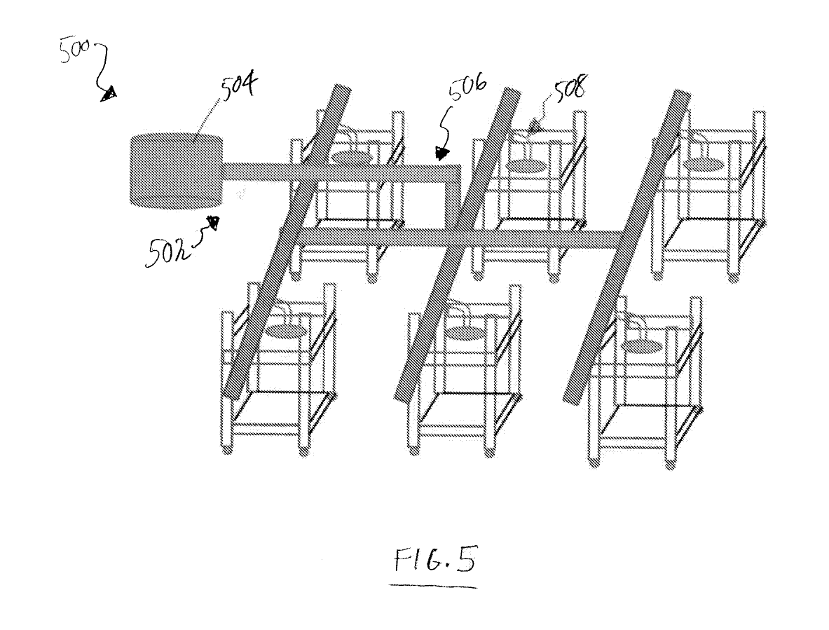

In addition to lighting systems and drainage systems, agricultural devices 100 incorporating features of the present invention can be incorporated with various feeding and nutrient distribution systems. FIG. 5 shows an agricultural system 500 comprising one or more agricultural devices 100 (six shown) and a nutrient distribution system 502. The nutrient distribution system 502 can comprise a nutrient storage tank 504 for storing water, fertilizer or other nutrients, a nutrient distribution manifold 506 and one or more nutrient distribution conduits 508 (six shown). The nutrient storage tank 504 can comprise any structure, shape and material suitable for storing a particular nutrient, with the preferred material being waterproof or at least partially water resistant such that damage and ware from stored liquid is mitigated. The nutrient distribution manifold 506 can comprise materials, structures and configurations similar to the drainage manifold 302 in FIGS. 3-4 above and the corresponding description is incorporated into this embodiment. In some embodiments, the nutrient storage tank 504 and or the nutrient distribution manifold 506 can be enclosed within the ceiling or wall of a room, with the nutrient distribution conduits 508 emerging from the wall or ceiling.

The nutrient distribution conduits 508 can comprise any structure, material and configuration suitable for the distribution of fluid, for example, water or liquid fertilizer. In some embodiments, the nutrient distribution conduits 508 comprise retractable and/or elastic hoses that can effectively vary in relative length. For example, the hoses can stretch or extend from a portion of a nearby wall or ceiling and move closer to an agricultural device 100 when a growing plant within that device needs a particular nutrient and can retreat or go back to a resting position near the ceiling or otherwise be positioned such that the nutrient distribution conduits 508 will not impede efficient movement of the agricultural devices 100.

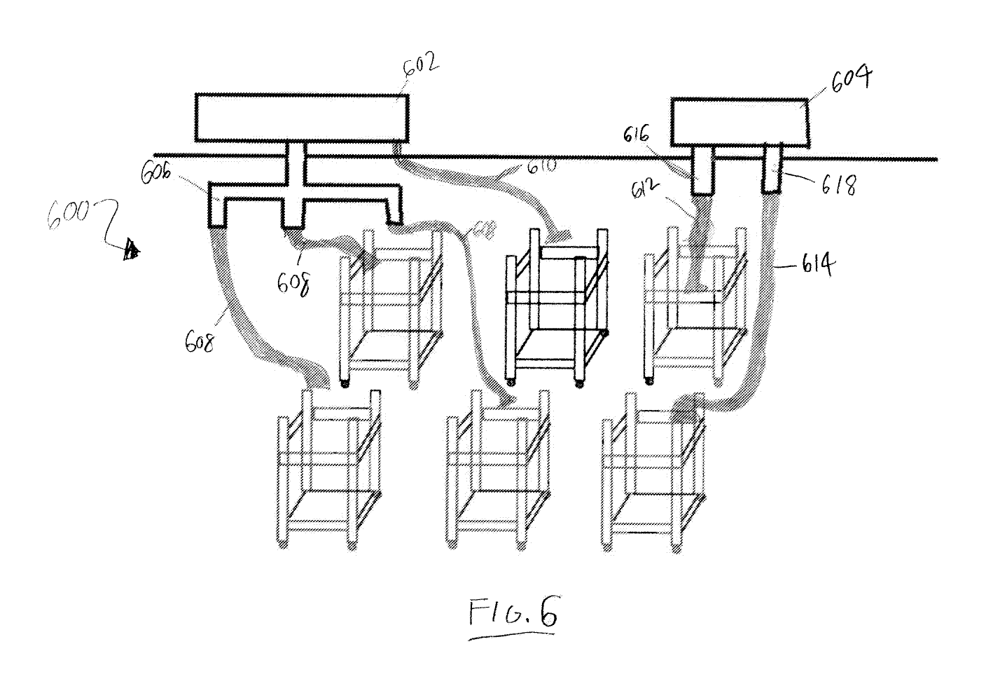

While a common nutrient manifold 506 from a common nutrient storage tank 504 is shown in FIG. 5, resulting in each agricultural device 100 within a plurality receiving the same nutrient, other configurations incorporating features of the present invention are also possible. FIG. 6 shows additional example configurations of how a nutrient storage tank, nutrient distribution manifold and nutrient distribution conduits can be configured. FIG. 6 shows an example agricultural system 600, wherein a plurality of agricultural devices 100 are configured such that some plants within different agricultural devices 100 are receiving different nutrients.

The agricultural system 600 of FIG. 6 comprises a plurality of agricultural devices 100 (six devices shown), a first nutrient storage tank 602 containing a first nutrient and a second nutrient storage tank 604 containing a second nutrient. As shown in FIG. 6, many different configurations of the different nutrient distribution components is possible. For example, the first nutrient storage tank 602 can supply the first nutrient to some of the agricultural devices 100 within the plurality through a common first nutrient distribution manifold 606 and a first set of commonly connected nutrient distribution conduits 608. The same nutrient storage tank 602 can supply one or more other agricultural devices 100 with the first nutrient through a first individual nutrient distribution conduit 610, which can be directly connected to the first nutrient storage tank 602, without an intervening nutrient distribution manifold. Utilizing this configuration, one group of plants within a first group of agricultural devices can receive a relatively uniform distribution of the first nutrient, while one or more other plants within other agricultural devices can receive an amount or level of the first nutrient that differs from the first group.

Utilizing a configuration such as that shown in FIG. 6, one can also supply a second nutrient to groups of agricultural devices 100 or individual agricultural devices. FIG. 6 shows two agricultural devices receiving the second nutrient from the second nutrient storage tank 604 through a second individual nutrient distribution conduit 612 and a third individual nutrient distribution conduit 614. Unlike the first individual nutrient distribution conduit 610, the second individual nutrient distribution conduit 612 and a third individual nutrient distribution conduit 614 are not directly connected to a nutrient storage tank, but are instead connected to a first intermediate individual nutrient distribution manifold 616 and a second intermediate individual nutrient distribution manifold 618 respectively. The intermediate individual nutrient distribution manifolds 616, 818 are in turn connected to the second nutrient storage tank 604.

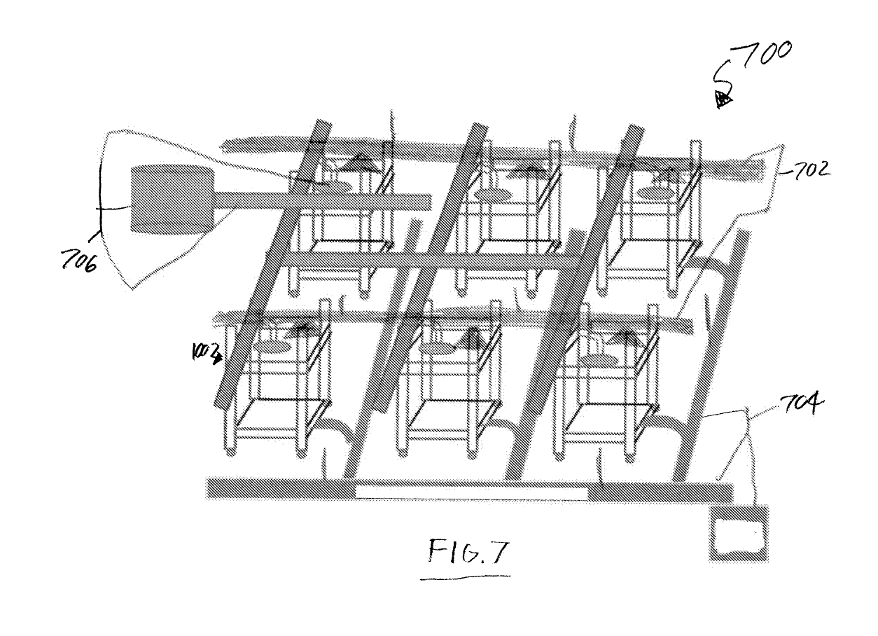

An overview of an agricultural system 700 incorporating one or more agricultural devices 100 (six shown), a lighting distribution system 702, a drainage system 704 and a nutrient distribution system 706 is shown in FIG. 7. FIG. 7 illustrates how the various systems including the lighting systems described herein in relation to FIG. 2, the drainage systems described herein in relation to FIGS. 3-4 and the nutrient distribution systems described herein in relation to FIGS. 5-6 can be combined with the agricultural devices described in FIG. 1 to achieve a comprehensive agricultural system 700. Each of the lighting distribution system 702, the drainage system 704 and the nutrient distribution system 706 can be moved and utilized such that the components of the system can be positioned to provide the necessary function (e.g. drainage for the drainage system 704) and be positioned such that the agricultural devices 100 can be freely moved without affecting any of the individual components when desired.

It is understood that while the agricultural devices 100 are particularly beneficial to vining plants and plants with multiple branching growth patterns, as these plants can fully grow into a growth lattice structure, it is understood that other plants can be utilized with devices, systems and methods incorporating features of the present disclosure and that the ability to freely move a growing plant into various environments, for example, established lighting and drainage systems, without disrupting other plants within those systems is beneficial. Some examples of vining or prolific branching plants that especially benefit from embodiments incorporating features of the present invention include tomatoes, grapes, ivy-like plants, and in case where it is legally produced with for a proper purpose with the correct government authorizations, cannabis plants.

It is understood that while various mechanical and manual methods for moving the various components of the agricultural systems incorporating features of the present invention are described herein, that any of these systems can be fully automated through any known method or device, for example by being controlled by a computer or control circuit.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

I claim:

1. An agricultural device, comprising:
a body comprising at least one base portion;
a growth lattice on said body and positioned a distance away from said base portion; and
at least one mobility structure configured to allow said agricultural device to move in relation to said at least one mobility structure

2. The agricultural device of claim 1, wherein said body further comprises one or more post portions connected to and extending away from said at least one base portion.

3. The agricultural device of claim 2, wherein said growth lattice is on one of said one or more post portions.

4. The agricultural device of claim 2, wherein said at least one mobility structure is on one of said one or more post portions.

5. The agricultural device of claim 2, further comprising an architectural support portion connected to said one or more post portions.

6. The agricultural device of claim 1, wherein said at least one mobility structure comprises at least one wheel.

7. The agricultural device of claim 1, wherein said one or more post portions are substantially perpendicular to said at least one base portion.

8. The agricultural device of claim 1, further comprising an internal drainage system.

9. The agricultural device of claim 8, wherein said internal drainage system is in said base portion.

10. The agricultural device of claim 1, further comprising at least one internal lighting element.

11. An agricultural system, comprising:
at least one agricultural device comprising:
a body comprising at least one base portion; and
at least one mobility structure configured to allow said agricultural device to move in relation to said at least one mobility structure; and
a drainage manifold connected to said at least one agricultural device.

12. The agricultural system of claim 11, wherein said drainage manifold is removably connected to said at least one agricultural device.

13. The agricultural system of claim 12, wherein said drainage manifold is moveable in relation to said at least one agricultural device.

14. The agricultural system of claim 13, wherein said drainage manifold is connected to a suspension mechanism configured to raise or lower said drainage manifold.

15. The agricultural system of claim 11, further comprising a drainage removal portion configured to remove liquid from said agricultural system.

16. The agricultural system of claim 15, wherein said drainage manifold is configured such that fluid within said drainage manifold flows toward said drainage removal portion primarily due to gravity.

17. The agricultural system of claim 11, further comprising at least one external lighting structure.

18. The agricultural system of claim 17, wherein said at least one external lighting structure comprises a plurality of lighting elements on a base portion and wherein said base portion can be raised or lowered in relation to said at least one agricultural device.

19. The agricultural system of claim 11, further comprising a nutrient distribution system.

20. The agricultural system of claim 19, wherein said nutrient distribution system comprises a nutrient storage tank positioned above said at least one agricultural device and further comprises at least one nutrient distribution conduit.

21. The agricultural system of claim 20, wherein said at least one nutrient distribution conduit is extendable and retractable.

22. An agricultural method of growing a plurality of plants, comprising the steps of:
providing at least two areas, said at least two areas comprising a first area comprising growing conditions conducive to desirable growth of a specific type of plant within a first stage of its growth cycle and a second area comprising growing conditions conducive to desirable growth of said specific type of plant within a second stage of its growing cycle;
providing a first plurality of plants of said specific type of plant within the first stage of its growing cycle on mobile agricultural devices in said first area and providing a second plurality of plants of said specific type of plant within the second stage of their growing cycle on mobile agricultural devices in said second area;
removing at least one plant on a mobile agricultural device within said second plurality of plants from said second area when said at least one plant advances past said second stage of its growth cycle; and
replacing said at least one plant with another plant from said first plurality of plants.
